(19) United States
(12) Patent Application Publication
(10) Pub. No.: US 2008/0168076 A1
(43) Pub. Date: Jul. 10, 2008

(54) DIGITAL AUDIO RIPPING DEVICE

(75) Inventors: Yung-Hsien Chang, Taipei (TW); Lun-Chuan Chang, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: INVENTEC MULTIMEDIA & TELECOM CORPORATION, Taipei (TW)

(21) Appl. No.: 11/621,075

(22) Filed: Jan. 8, 2007

(51) Int. Cl. G06F 17/30

(52) U.S. Cl. 707/101; 707/E17.009

(57) ABSTRACT

A digital audio ripping device is proposed, which is designed for use to convert the digital audio data that are stored in a particular format on a storage medium, such as Audio CD files, into a standard computer multimedia format, such as the MP3 format, such that the user can utilize a portable MP3 player for playback of MP3-formatted digital audio files extracted from Audio CD. The proposed digital audio ripping device is characterized by the capability of Audio CD ripping to an MP3 multimedia player without having to use a PC, and the capability of performing a folder reorganizing procedure in the event of the MP3 multimedia player being downloading and installing an iTunes program via the Internet so as to allow the MP3 multimedia player to use the iTunes program for playback of the digital audio files extracted from the Audio CD.

### BACKGROUND OF THE INVENTION

1. Field of the Invention

This invention relates to multimedia technology, and more particularly, to a digital audio ripping device which is designed for use to convert the digital audio data that are stored in a particular format on a storage medium, such as Audio CD files, into a standard computer multimedia format, such as the MP3 format, without requiring the user to employ a personal computer, such that the user can quickly and conveniently utilize a portable MP3 player, such as iPod®, for playback of MP3-formatted digital audio files extracted from Audio CD.

2. Description of Related Art

An MP3 player is a portable multimedia playback device that allows a user to play MP3-formatted digital audio files prestored in a flash memory module. These MP3-formatted digital audio files can be either directly downloaded via the Internet, or extracted from Audio CD by way of a computer platform such as a desktop computer or notebook computer that runs a CD ripper program capable of converting the digital audio data on an Audio CD to MP3 format and storing the MP3-formatted digital audio files into the built-in flash memory module of the MP3 player.

One drawback to the utilization of the aforementioned CD ripper program, however, is that the user needs to utilize a PC to run the CD ripper program, and therefore, for PC dummies who are unfamiliar with PC operations, it would be very inconvenient or impossible for them to enjoy Audio CD music on a portable MP3 player. Moreover, the use of PC for Audio CD ripping to MP3 player requires the user to carry out a sequence of manual operations on the PC that are laborious and time-consuming, and therefore is quite inconvenient.

### SUMMARY OF THE INVENTION

It is therefore an objective of the present invention to provide a digital audio ripping device which allows the user to conveniently and quickly rip Audio CD music to a portable MP3 player without having to use a PC.

The digital audio ripping device according to the present invention is designed for use to convert the digital audio data that are stored in a particular format on a storage medium, such as Audio CD files, into a standard computer multimedia format, such as the MP3 format, without requiring the user to employ a personal computer, such that the user can quickly and conveniently utilize a portable MP3 player, such as iPod®, for playback of MP3-formatted digital audio files extracted from Audio CD.

In architecture, the digital audio ripping device according to the invention comprises: (A) an audio track extracting module, which is capable of extracting each digital audio stream stored on each audio track on the digital audio storage medium; (B) a format converting module, which is capable of converting each digital audio stream extracted by the audio track extracting module from the digital audio storage medium into a digital audio file of a standard computer multimedia format; (C) a folder creating module, which is capable of creating a folder in the multimedia player; and (D) a file storing module, which is capable of storing each format-converted digital audio file produced by the format converting module into the folder in the multimedia player created by the folder creating module.

The digital audio ripping device according to the invention is characterized by the capability of Audio CD ripping to an MP3 multimedia player without having to use a PC, and the capability of performing a folder reorganizing procedure in the event of the MP3 multimedia player being downloading and installing an iTunes program via the Internet so as to allow the MP3 multimedia player to use the iTunes program for playback of the digital audio files extracted from the Audio CD.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application of the digital audio ripping device of the invention when performing a ripping procedure;

FIG. 2 is a schematic diagram showing the internal architecture of the digital audio ripping device of the invention;

FIG. 3 is a schematic diagram showing the application of a multimedia player downloading an iTunes program by way of a PC linked to the Internet; and

FIG. 4 is a schematic diagram showing an example of a folder structure created by a downloaded iTunes program on an iPod® multimedia player.

### DETAILED DESCRIPTION OF PREFERRED EMBODIMENTS

The digital audio ripping device according to the invention is disclosed in full details by way of preferred embodiments in the following with reference to the accompanying drawings.

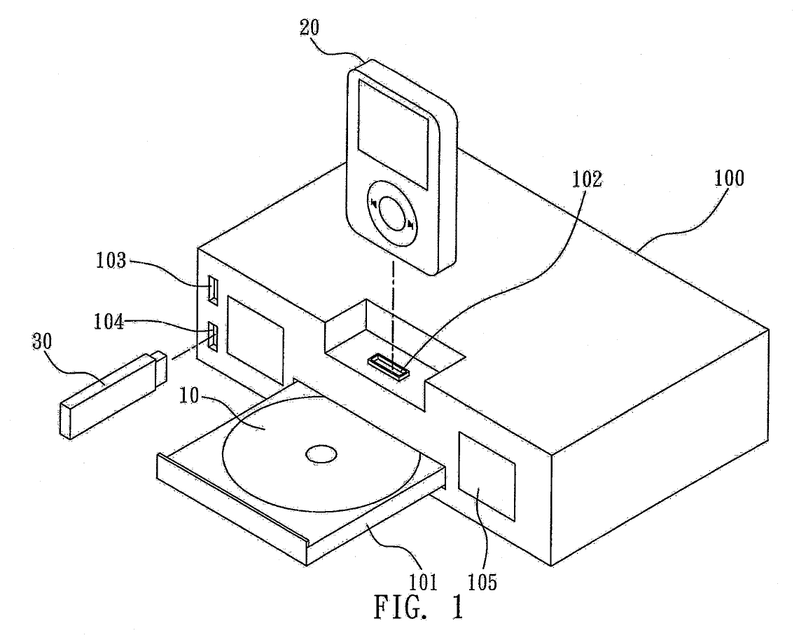

FIG. 1 is a schematic diagram showing the application of a digital audio ripping device 100 of the present invention. The digital audio ripping device 100 is a portable and independent device, which is equipped with a DVD/CD drive 101, an adapter 102, a USB connector 103, a memory adapter 104, and a control panel 105. The DVD/CD drive 101 is used to hold an optical disc, such as a DVD or a CD, that stores a set of digital audio streams in a particular format, such as the Audio CD format. The adapter 102 and the USB connector 103 can be selectively used for connection to a multimedia player 20, such as an MP3 player or an iPod®. The memory adapter 104 is used for connection to a memory module 30, such as CF, SM, MD, or MMC flash memory card, that is acceptable by MP3 or iPod® players. The control panel 105 is used to provide control means that allows the user to operate the digital audio ripping device 100.

In actual application, the user needs just to insert a digital audio storage medium, typically a digital audio disc 10 such as an Audio CD, into the DVD/CD drive 101, and meanwhile connect the multimedia player 20 (MP3 player or iPod®) to the digital audio ripping device 100 via either the dedicated adapter 102 or the USB connector 103 (alternatively, the user can choose to insert just the memory module 30 of the multimedia player 20 via the memory adapter 104 to the digital audio ripping device 100. After ripping is completed, the user needs to insert the memory module 30 back to the multimedia player 20). Next, the user can utilize the control panel 105 to initiate a ripping procedure by pressing a button. This will cause the digital audio ripping device 100 to extract the digital audio data on each audio track on the digital audio disc 10 and covert the extracted digital audio data to a standard computer multimedia format, such as MP3, Windows Digital Audio (WAV), Windows Media Audio (WMA), or OGG. Each format-converted digital audio file is then stored into a built-in memory module 21 (which is typically a flash memory module) of the multimedia player 20, so that the user can utilize the multimedia player 20 to play the format-converted digital audio files extracted from the digital audio disc 10.

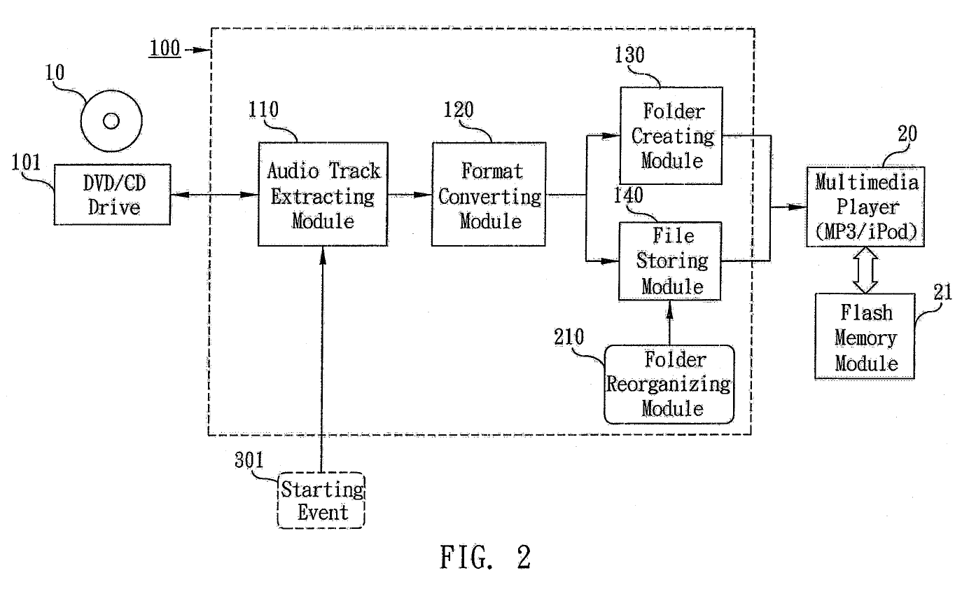

As shown in FIG. 2, in architecture, the digital audio ripping device 100 comprises an audio track extracting module 110, a format converting module 120, a folder creating module 130, and a file storing module 140. The digital audio ripping device 100 can further optionally comprise a folder reorganizing module 210.

The audio track extracting module 110 is capable of being activated in response to a user-operated starting event 301 (which is initiated when the user presses a starting button on the control panel 105) to extract the digital audio data stored on each audio track on the digital audio disc 10.

The format converting module 120 is capable of converting each Audio CD formatted digital audio stream extracted by the audio track extracting module 110 from the digital audio disc 10 into a standard computer multimedia format, such as MP3, WAV, WMA, or OGG. If multiple formats are available for the conversion, the user can utilize the control panel 105 to select the desired format.

The folder creating module 130 is capable of creating a dedicated folder in built-in memory module 21 of the multimedia player 20 for storing each format-converted digital audio file produced by the format converting module 120.

The file storing module 140 is capable of storing each format-converted digital audio file produced by the format converting module 120 into the dedicated folder in the built-in memory module 21 of the multimedia player 20 created by the folder creating module 130.

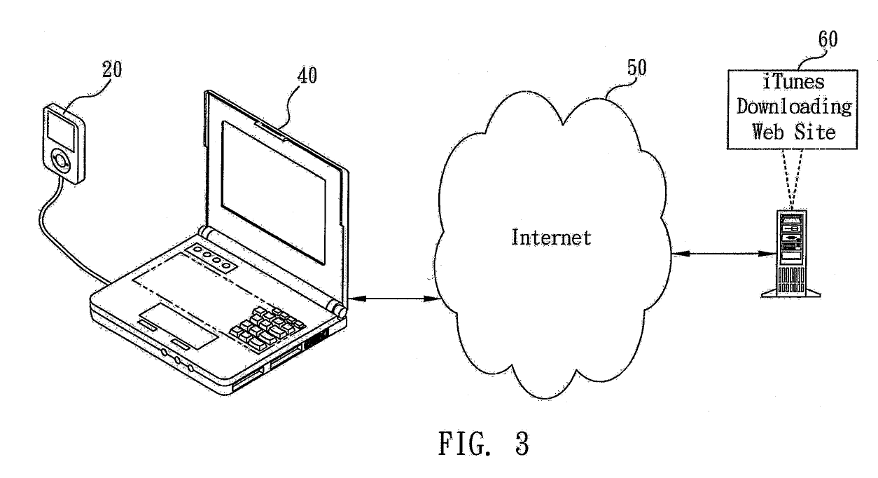

The folder reorganizing module 210 is implemented with a computer program which is prestored in the digital audio ripping device 100. When the multimedia player 20 is connected to the digital audio ripping device 100, the computer program can be transferred by the file storing module 140 for storage together with the format-converted digital audio file in the built-in memory module 21 of the multimedia player 20. This folder reorganizing module 210 can be activated in the event that the multimedia player 20 is linked via a PC 40 and the Internet 50 to an iTunes downloading Web site 60 for downloading an iTunes program therefrom, as illustrated in FIG. 3. When activated, this folder reorganizing module 210 is capable of reorganizing the dedicated folder where the format-converted digital audio file is stored into a new folder, that is recognizable by the downloaded iTunes program.

The following is a detailed description of a practical application example of the digital audio ripping device 100 during actual operation. In this application example, it is assumed that the user wants to rip all digital music pieces stored on a digital audio disc 10 (i.e., Audio CD) to an MP3 multimedia player 20. In this case, the user needs just to first insert the digital audio disc 10 into the DVD/CD drive 101 and meanwhile connect the MP3 multimedia player 20 to the digital audio ripping device 100 via either the dedicated adapter 102 or the USB connector 103, and then utilize the control panel 105 to activate a ripping procedure.

In the beginning of the ripping procedure, the audio track extracting module 110 is first activated to extract the digital audio data stored on each audio track on the digital audio disc 10. Next, the format converting module 120 is activated to convert each Audio CD formatted digital audio stream extracted by the audio track extracting module 110 from the digital audio disc 10 into a standard computer multimedia format. In this example, the user-selected format is MP3. Subsequently, the folder creating module 130 is activated to create a dedicated folder in the storage space of the built-in memory module 21 of the multimedia player 20, and then the file storing module 140 is activated to store each MP3-formatted digital audio file produced by the format converting module 120 into the dedicated folder in the built-in memory module 21 of the multimedia player 20. After this, the user can utilize the MP3 multimedia player 20 for playback of the MP3-formatted digital audio files extracted from the digital audio disc 10.

In the case that the MP3 multimedia player 20 is an iPod® device, the user is allowed to download an iTunes program via a PC 40 and the Internet 50 from an iTunes downloading Web site 60, and utilize the downloaded iTunes program for playback of the MP3-formatted digital audio files extracted from the digital audio disc 10. However, during the installation of the downloaded iTunes program, the iTunes program will create a dedicated file management system for all data that are to be stored in the built-in memory module 21 of the MP3 multimedia player 20, thus undesirably erasing the dedicated folder created by the folder creating module 130 and all the MP3-formatted digital audio files stored therein. This problem can be resolved by using the folder reorganizing module 210, as described below.

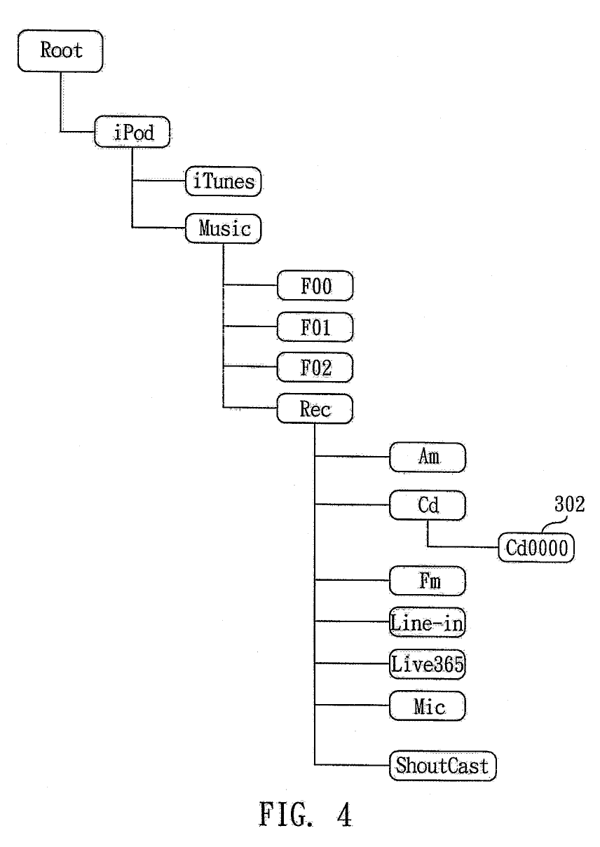

As the user activates the MP3 multimedia player 20 to start an iTunes downloading procedure, the folder reorganizing module 210 is simultaneously activated to perform a folder reorganizing procedure, which includes a first step of temporarily relocating all the MP3-formatted digital audio files stored in the folder created by the folder creating module 130 to the PC 40 (i.e., for temporary storage on the hard disk of the PC 40). Then, after the downloaded iTunes program has created its dedicated file management system on the built-in memory module 21 of the MP3 multimedia player 20 (as illustrated in FIG. 4), the folder reorganizing module 210 creates a new digital audio file folder 302 in the iTunes-created folder structure (which is named “cd0000” in FIG. 4, for example), and then moves all the MP3-formatted digital audio files from the PC 40 to the folder 302. This allows the iTunes program to play the MP3-formatted digital audio files stored in the folder 302.

In conclusion, the invention provides a digital audio ripping device which is designed for use to convert the digital audio files stored in a particular format on a storage medium, such as Audio CD files, into a computer-acceptable format, such as the MP3 format, without using a personal computer, such that the user can quickly and conveniently utilize a portable MP3 player, such as iPod®, to play the original audio files on Audio CD. The digital audio ripping device of the invention is characterized by the capability of Audio CD ripping to an MP3 multimedia player without having to use a PC, and the capability of performing a folder reorganizing procedure in the event of the MP3 multimedia player being downloading and installing an iTunes program via the Internet to allow the MP3 multimedia player to use the iTunes program for playback of the digital audio files extracted from the Audio CD. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A digital audio ripping device for use to rip and store digital audio streams originally recorded in a plurality of audio tracks of a digital audio storage medium in a multimedia player, the digital audio ripping device comprising:
an audio track extracting module which is capable of extracting the digital audio streams recorded in the audio tracks of the digital audio storage medium;
a format converting module which is capable of converting the digital audio streams extracted by the audio track extracting module from the digital audio storage medium into a digital audio file having a standard computer multimedia format;
a folder creating module which is capable of creating a folder in the multimedia player; and
a file storing module which is capable of storing the digital audio file produced by the format converting module into the folder created by the folder creating module.

2. The digital audio ripping device of claim 1, wherein the digital audio disc is an Audio CD.

3. The digital audio ripping device of claim 1, wherein the standard computer multimedia format converted by the format converting module is MP3.

4. The digital audio ripping device of claim 1, wherein the standard computer multimedia format converted by the format converting module is Windows Digital Audio (WAV).

5. The digital audio ripping device of claim 1, wherein the standard computer multimedia format converted by the format converting module is Windows Media Audio (WMA).

6. The digital audio ripping device of claim 1, wherein the standard computer multimedia format converted by the format converting module is OGG.

7. The digital audio ripping device of claim 1, further comprising:
a folder reorganizing module which is implemented with a computer program which is stored by the file storing module in the multimedia player, and which is capable of being activated in response to an event of the multimedia player being downloading and installing a multimedia playback program to reorganize the folder where the format-converted digital audio file is stored into a new folder that is recognizable by the downloaded multimedia playback program.
